(19) United States
(12) Patent Application Publication
(10) Pub. No.: US 2023/0400835 A1
(43) Pub. Date: Dec. 14, 2023

(54) A SYSTEM FOR ASSISTING A USER IN A MULTI-PHASE PROCESS AND A METHOD THEREOF

(71) Applicant: SIGNIFY HOLDING B.V., EINDHOVEN (NL)

(72) Inventor: HARRY BROERS, 'S-HERTOGENBOSCH (NL)

(21) Appl. No.: 18/031,433

(22) PCT Filed: Oct. 7, 2021
(86) PCT No.: PCT/EP2021/077657

§ 371 Date: Apr. 12, 2023

(30) Foreign Application Priority Data
Oct. 12, 2020 (EP) 20201206.8

(51) Int. Cl. G05B 19/4155; H04B 10/116; G06V 10/145

(52) U.S. Cl. CPC G05B 19/4155; G05B 2219/35513; G06V 10/145; H04B 10/116

(57) ABSTRACT

A system (100) for assisting a user in a process is disclosed. The process comprises a plurality of process phases. The system (100) comprises: a lighting unit (120) configured to emit light comprising an embedded code (130), the embedded code 130 being representative of a process phase of the process, and a tool (102) comprising: a user input element 108 configured to receive a user input to activate the tool (102), a light detector (104) configured to detect the light emitted by the lighting unit (120), and a processor (106) configured to extract the embedded code (130) from the detected light, to determine a tool setting for the tool (102) based on the embedded code (130), to configure the tool (102) based on the tool setting such that when the user input is received, the tool (102) is controlled in accordance with the tool setting.

### FIELD OF THE INVENTION

The invention relates to a system for assisting a user in a process which comprises a plurality of process phases. The invention further relates to a tool for assisting a user in a process which comprises a plurality of process phases. The invention further relates to a method of assisting a user in a process which comprises a plurality of process phases.

### BACKGROUND

During different processes the same equipment is typically used at different locations or in different phases of the process. In these different phases or locations, the required operating characteristics of tools may be different. Example of processes are manufacturing or production processes, medical processes, cleaning processes, etc. For example, the required revolution speed and torque of cordless precision fasteners may differ for different process phases in a production process, the required settings for medical equipment may differ for different process phases in a medical process, the required settings for a cleaning device may differ during different phases of the cleaning process, etc.

### SUMMARY OF THE INVENTION

The inventors have realized that it may be beneficial to assist a user in providing the required tool settings at the right moment and/or at the relevant location during a process. It is therefore an object of the present invention to assist a user in setting the correct tool settings of a tool in a process that requires the tool.

According to a first aspect of the present invention, the object is achieved by a system for assisting a user in a process, the process comprising a plurality of process phases, the system comprising:
a lighting unit configured to emit light comprising an embedded code, the embedded code being representative of a process phase of the process, and
a tool comprising:
   a user input element configured to receive a user input to activate the tool,
   a light detector configured to detect the light emitted by the lighting unit, and
   a processor configured to extract the embedded code from the detected light, to determine a tool setting for the tool based on the embedded code, to configure the tool based on the tool setting such that when the user input is received, the tool is controlled in accordance with the tool setting.

By controlling the light output of the lighting unit such that it provides an embedded code which is representative of the process phase, the tool can detect the code and set the required tool settings that correspond to the process phase. As a result, the light output of the lighting unit creates a zone (which is defined by the beam of the light emitted by the lighting unit) wherein the tool is automatically configured according to the required tool settings. This is beneficial because the user operating the tool is assisted during the process phase of the process.

The system may comprise a plurality of lighting units each configured to emit light comprising a respective embedded code, each respective embedded code being representative of a respective process phase of the process. The processor may be configured to extract a respective embedded code from detected respective light, to determine a respective tool setting for the tool based on the respective embedded code, and configure the tool based on the respective tool setting. When the user input is received, the tool may be controlled according to the respective tool setting. The system may comprise a plurality of lighting units which each create a zone that represents a process phase of the process. During a first process phase at a first location the required tool settings may be different from the tool settings required during a second process phase at a second location. A first lighting unit may be located at the first location, emitting light comprising a first embedded code representative of the first process phase, and a second lighting unit may be located at the second location, emitting light comprising a second embedded code representative of the second process phase tool. This is beneficial because the user is assisted during multiple process phases of the process.

The tool may comprise a user interface, and the processor may be configured to, if the embedded code has not been detected or if no tool setting has been determined, provide a notification thereof via the user interface. The user interface may, for example, be a display, an indicator LED, an auditory user interface, a haptic user interface, etc. This is beneficial, because the user can be informed when the (respective) tool setting has not been or can not be set. Additionally, the tool may be configured to receive user input for manually setting the tool to the required tool setting.

The system may comprise a controller configured to instruct the lighting unit to embed data indicating the process phase in the embedded code, and the processor may be configured to extract the process phase from the embedded code, and to determine the tool setting for the tool based on the extracted process phase. In other words, the process phase may be comprised in the embedded code, and the process phase may be extracted therefrom. This is beneficial, because the processor may directly determine the tool setting based on the data comprised in the embedded code. Alternatively, the embedded code may be a predefined embedded code, and the processor may be configured to access a memory comprising associations between predefined embedded codes and tool settings. The processor may be further configured to retrieve the tool setting from the memory by comparing the detected predefined embedded code with the stored predefined embedded codes and by selecting the tool setting that corresponds to the detected predefined embedded code. The predefined embedded code may, for example, be a fixed code, for instance representative of an identifier of the lighting unit. This is beneficial because it does not require updating/changing the embedded code.

The tool setting may comprise an actuation setting for an actuator of the tool. The actuator may be a component of the tool that is responsible for moving physical element of the tool. The actuation setting may be a tool activation setting. The actuation setting may be defined as a value in a range of values (e.g. from a minimum “on” value (e.g. 1%) to a maximum “on” value (e.g. 100%)). The setting of the actuator may, may for instance set a revolution speed or a torque setting of the tool. Alternatively, the tool setting may be a deactivation of an actuator of the tool. It may be beneficial for safety purposes that the actuator is fully deactivated. The tool may comprise a first actuator and a second actuator, and the tool setting may comprise an actuation setting for the first actuator of the tool and a deactivation for the second actuator of the tool.

The lighting unit may be a lighting unit for providing illumination of a space where the process phase is to be executed by the user. In other words, the lighting unit may illuminate the space where the user is operating the tool during the (respective) process phase. The lighting unit may therefore provide two functions, i.e. providing illumination of the space and providing the embedded code representative of the process phase.

The process may be a production process, for example a manufacturing process, a testing process, an assembly process, etc.

The tool may be required during at least two process phases in the process. For instance, the tool may be required during a first process phase wherein a first tool setting is required, and during a second process phase wherein a second tool setting is required. The processor may be configured to switch from the first tool setting to the second tool setting when a detected embedded code indicates the second process phase.

The process phase may be dependent on the current time. Some processes are synchronized with time, and different process phases may be associated with the time, for instance a certain time of day.

The processor may be configured to receive an indication that the process phase has been completed by the user. The processor may, for example, in response to receiving the completion indication, transmit a signal to the lighting unit to update the embedded code or the process phase associated with the embedded code such that the embedded code represents a next process phase of the process. This enables moving/switching to the new process phase. The use may provide the indication via a user interface. Alternatively, the indication that the process phase has been completed by the user may be determined or detected by the processor. The processor may for instance be configured to determine that the process phase has been completed after a period of time has lapsed, or for instance if the user no longer provides the user input.

According to a second aspect of the present invention, the object is achieved by a tool for use in the system, the tool comprising:
a user input element configured to receive a user input to activate the tool,
a light detector configured to detect light emitted by a lighting unit, the light comprising a code embedded in the light, the embedded code being representative of a process phase of the process, and
a processor configured to extract the embedded code from the detected light, to determine a tool setting for the tool based on the embedded code, and to configure the tool based on the tool setting such that when the user input is received, the tool is controlled in accordance with the tool setting.

According to a third aspect of the present invention, the object is achieved by a method of assisting a user in a process, the process comprising a plurality of process phases, the method comprising:
detecting the light emitted by a lighting unit, the light comprising an embedded code being representative of a process phase of the process,
extracting the embedded code from the detected light,
determining a tool setting for the tool based on the embedded code,
receiving a user input to activate the tool, and
configuring the tool based on the tool setting such that when the user input is received, the tool is controlled in accordance with the tool setting.

It should be understood that the tool and the method may have similar and/or identical embodiments and advantages as the above-mentioned systems.

### BRIEF DESCRIPTION OF THE DRAWINGS

The above, as well as additional objects, features and advantages of the disclosed systems, devices and methods will be better understood through the following illustrative and non-limiting detailed description of embodiments of devices and methods, with reference to the appended drawings, in which:

FIG. 1 shows schematically a system for assisting a user in a process;

FIG. 2 shows schematically a system for assisting a user in a process, the system comprising a memory storing information about process phases;

FIG. 3 shows schematically a system comprising multiple lighting units for assisting a user in a process; and

FIG. 4 shows schematically a method of assisting a user in a process.

All the figures are schematic, not necessarily to scale, and generally only show parts which are necessary in order to elucidate the invention, wherein other parts may be omitted or merely suggested.

### DETAILED DESCRIPTION OF EMBODIMENTS

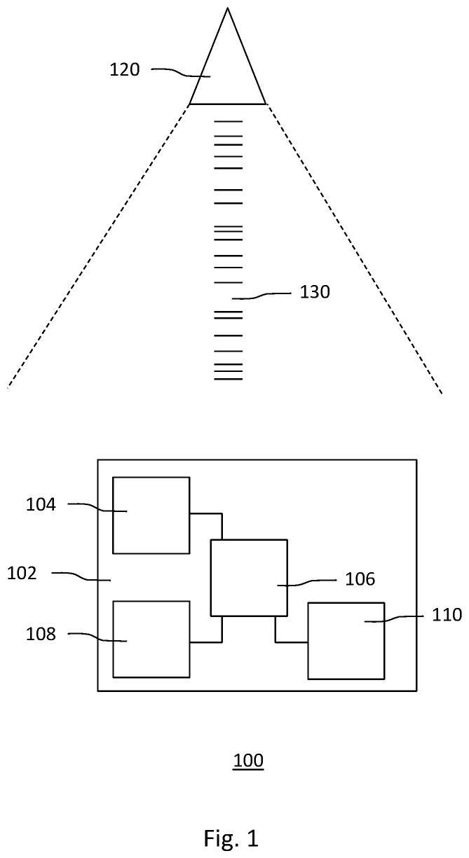

FIG. 1 shows schematically a system 100 for assisting a user in a process which comprises a plurality of process phases. The system comprises a lighting unit 120 and a tool 102 to be used in the process.

The lighting unit 120 comprises one or more (LED) light sources for emitting light. The lighting unit 120 is configured to emit light comprising a code 130 embedded in the light. The code may be created by any known principle of embedding a code in light, for example by controlling a time-varying, modulated current to the one or more light sources to produce variations in the light output, by modulating the amplitude and/or the duty-cycle of the light pulses, etc. Such techniques (e.g. Visible Light Communication, Li-Fi, Free-space optical communication, etc.) are known in the art and will therefore not be discussed in detail. The lighting unit 120 may be a lighting unit 120 for providing illumination of a space where the process phase is to be executed by the user. In other words, the lighting unit 120 may illuminate the space with visible where the user is operating the tool during the process phase.

The tool 102 is a tool to be used in the process. The process may, for example, be a production process such as an assembly, manufacturing or testing process, which may be executed in a production environment such as a factory, an assembly line, etc. The tool 102 may be a tool held by the user. The tool 102 may be a portable tool. The tool 102 may be a power tool and may, for example, be a fastening tool comprising an actuator to actuate a fastening element (e.g. a screw driver, an impact wrench, etc.), a drilling tool comprising an actuator to actuate a drilling element (e.g. a), a power tool comprising an actuator to actuate a rotary element such as a cutter disc, a sander disc or an angle grinder disc, a nail gun comprising an actuator to drive a nail from the gun, a saw comprising an actuator to actuate a saw blade (e.g. a sabre saw, a reciprocating saw, a jigsaw, etc.), etc. The tool 102 may be an appliance and may, for example, be a cleaning device (e.g. a vacuum cleaner, a wet cleaning machine, etc.) comprising an actuator to drive a component of the cleaning device, a lawn mower or other garden equipment comprising an actuator to drive a component of the garden equipment, a disinfection device (e.g. a (portable) UV lamp), mobile medical equipment, etc. The tool 102 may be driven electrically, pneumatically, be combustion powered, etc.

The process comprises a plurality of different process phases. The process phases each require different tool settings of the tool 102. The tool settings may, for example, define an actuation setting or a deactivation setting of one or more actuators 110 of the tool. The actuator 110 may be a component of the tool that is responsible for moving a physical element of the tool, such as a rotary element (e.g. a motor), a pneumatic element, etc. The actuation setting may be a tool activation setting. The actuation setting may be defined as a value in a range of values (e.g. from a minimum “on” value (e.g. 1%) to a maximum “on” value (e.g. 100%)). The setting of the actuator 110 may, may for instance set a revolution speed, a cutting speed, a torque setting, a force exerted by the actuator, etc. of the tool 102. Alternatively, the tool setting may be a deactivation of an actuator of the tool 102. The tool 102 may comprise a first actuator and a second actuator, each responsible for moving a respective physical element of the tool, and the tool setting may comprise an actuation setting of the first actuator of the tool 102 and a deactivation of the second actuator of the tool 102. Alternatively, the tool settings may, for example, define a sensor setting of one or more sensors of the tool 102. The sensor setting may, for example, be a reference value (e.g. a threshold value), a gain, a magnification, etc. for a sensor comprised in the tool 102. The sensor may, for example, be a pressure sensor (e.g. for an inflating/deflating tool), a light sensor (e.g. of a spectrometer), etc.

The tool 102 comprises a user input element 108 configured to receive a user input to activate the tool 102. The user input element 108 may, for example, be a push button, a trigger, a touch sensitive surface, etc. A user may provide the user input via the user input element 108, whereupon an actuator 110 of the tool 102 is actuated according to a tool setting which corresponds to the process phase, or whereupon a sensor is activated according to a tool setting which corresponds to the process phase.

The tool 102 comprises a light detector 104 configured to detect the light and its embedded code 130 emitted by the lighting unit 120. The light detector 104 may for instance be a photodiode or a camera. Techniques for detecting a code embedded in light emitted by a lighting unit are known in the art and will therefore not be discussed in detail.

The tool 102 comprises a processor 106 configured to extract the embedded code 130 from the light detected by the light detector 104. The processor 106 is coupled to the light detector 104. The processor 106 is further configured to determine a tool setting for the tool 102 based on the embedded code 130 and to configure the tool 102 based on the tool setting such that when the user input is received via the user input element 108, the tool 102 is controlled in accordance with the tool setting. The process may, for example, comprise a first process phase, a second process phase and a third process phase, which each may require different tool settings for the tool. During the first process phase, the code 130 is representative of the first process phase, during the second process phase, the code 130 is representative of the second process phase and during the third process phase, the code 130 is representative of the third process phase. If the processor 106 extracts the code representative of the first process phase, the processor 106 determines a first tool setting that corresponds to the first process phase. If the processor 106 extracts the code representative of the second process phase, the processor 106 determines a second tool setting that corresponds to the second process phase. If the processor 106 extracts the code representative of the third process phase, the processor 106 determines a third tool setting that corresponds to the third process phase. The processor 106 may be coupled to the actuator 110 and set an actuation setting corresponding to the respective process phase.

The system 100 may comprise a (central) controller 140 configured to instruct the lighting unit 120 to embed data indicating the process phase in the embedded code 130. The processor 106 may be configured to extract the process phase from the embedded code, and to determine the tool setting for the tool 102 based on the extracted process phase. In other words, the process phase may be comprised in the embedded code 130, and the process phase may be extracted therefrom by the processor 106 which then selects the corresponding tool setting. The system 100 may comprise a memory 202, 204 storing associations between process phases and tool settings, and the controller 140 may be configured to select a tool setting from the memory that corresponds to the current process phase, and embed data indicating the current process phase in the embedded code 130. The controller 140 may for example be comprised in the remote server or in the lighting unit 120.

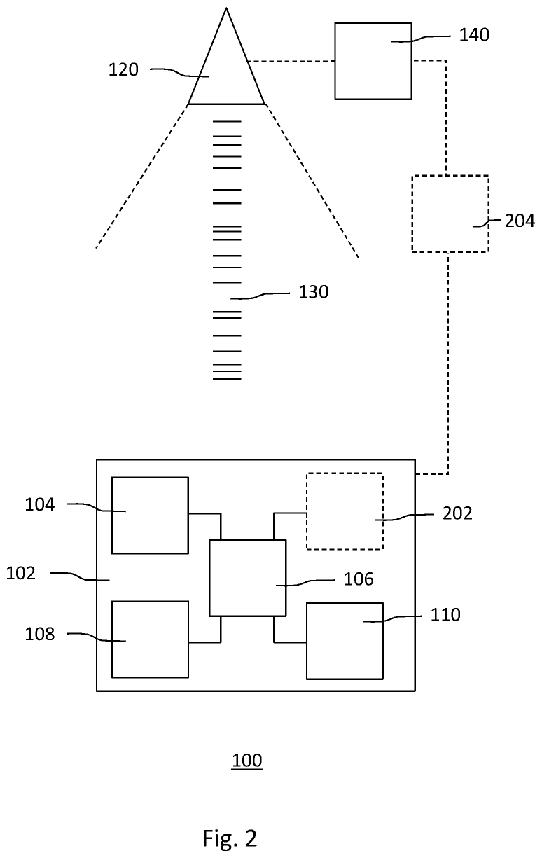

Alternatively, the embedded code 130 may be a predefined embedded code. The predefined code may remain unchanged when the process phase changes to a next process phase, and an association between the predefined embedded code and a process phase may be updated in a memory 202, 204. The processor 106 may be configured to access a memory 202, 204 comprising associations between predefined embedded codes and tool settings. The processor 106 may be further configured to retrieve the tool setting from the memory 202, 204 by comparing the detected predefined embedded code with the stored predefined embedded codes and by selecting the tool setting that corresponds to the detected predefined embedded code. The predefined embedded code may, for example, be a fixed code, for instance an identifier of the lighting unit. The memory 202 may be comprised in the tool 102 (see FIG. 2), and be directly accessible by the processor 106, or the memory 204 may be a remote memory. The remote memory may be accessible via a network (e.g. an RF network) or via the internet. The remote memory 204 may be for example be comprised in a remote server or in the controller 140. The controller 140 may for example be comprised in the remote server or in the lighting unit 120.

The controller 140 may be configured to control the lighting unit 120 such that the embedded code is dependent on the orientation of the lighting unit 120. The lighting unit 120 may comprise an orientation sensor, and the lighting unit 120 may be configured to communicate the orientation to the controller 140. The lighting unit 120 may, for example, illuminate an area where a certain process phase is to be performed. The location and the orientation of the lighting unit 120 relative to the area may be known by the controller 140 (e.g. based on information received from one or more orientation sensors comprised in the lighting unit 120, and/or based on information received from a positioning system), and the controller 140 may control the lighting unit 120 such that it emits light comprising a code representative of the process phase that is to be performed at the area.

The tool 102 may comprise an orientation sensor, and the tool setting may be determined based on the embedded code and based on the orientation of the tool 102. The processor 106 may, for example, receive a signal from the orientation sensor and determine the orientation of the tool 102 based thereon. The processor 106 may, for example, determine to set the tool 102 to a primary tool setting based on the current project phase if the tool 102 is positioned in a first orientation (e.g. horizontal), and to set the tool 102 to a secondary tool setting based on the current project phase if the tool 102 is positioned in a second orientation (e.g. vertical). Examples of tool settings that may be dependent on the orientation of the tool include but are not limited to the rotation speed or the rotation direction of a rotary element, the torque of a fastening element, the angle of an angle grinder, etc.

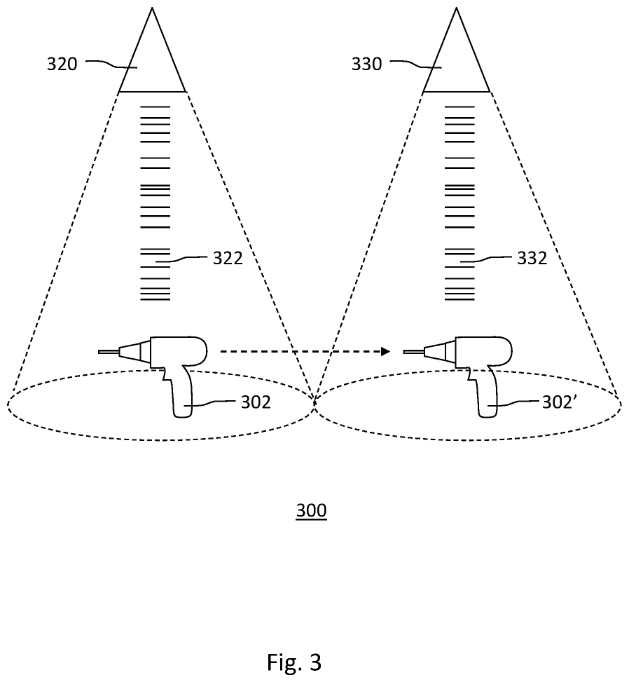

The system 100 may comprise a plurality of lighting units 120 each configured to emit light comprising a respective embedded code, each respective embedded code being representative of a respective process phase of the process. The processor 106 may be configured to extract a respective embedded code from detected respective light, to determine a respective tool setting for the tool based on the respective embedded code, and to configure the tool 102 based on the respective tool setting. When the user input is received, the tool may be controlled according to the respective tool setting. FIG. 3 illustrates an example of a system 300 that comprises a plurality of lighting units 320, 330 which each create a zone (indicated by the dashed ovals) that represents a process phase of the process. A first lighting unit 320 is configured to emit light comprising a first embedded code 322 representative of a first process phase of a process, and a second lighting unit 330 is configured to emit light comprising a second embedded code 332 representative of a second process phase of the process. During the first process phase, the user may use the tool 302 at a first location (e.g. in a first zone created by the light output of the first lighting unit 320). The processor (not shown) may then extract the first embedded code 322 and determine that the tool 302 is to be set to the first tool setting corresponding to the first process phase. After completing the first process phase, the user may use the same tool 302′ at a second location (e.g. in a second zone created by the light output of the second lighting unit 330). The processor (not shown) may then extract the second embedded code 332 and determine that the tool 302′ is to be set to the second tool setting corresponding to the second process phase.

The tool 102 may further comprise a user interface, and the processor 106 may be configured to, if the embedded code 130 has not been detected or if no tool setting has been determined, provide a notification thereof via the user interface. The user interface may, for example, be a display or an indicator LED. The processor 106 may thus inform when the (respective) tool setting has not been or cannot be set.

The processor 106 may be configured to receive an indication that the process phase has been completed by the user. The indication may be received from a user (e.g. via a user interface of the tool 102), or automatically, for instance based on sensor data of a sensor of the tool 102, from an actuator, etc. The processor 106 may, for example, in response to receiving the completion indication, transmit a signal to the lighting unit 120 to update the embedded code 130 or the process phase associated with the embedded code such that the embedded code represents a next process phase of the plurality of process phases. This enables switching to the new/next process phase.

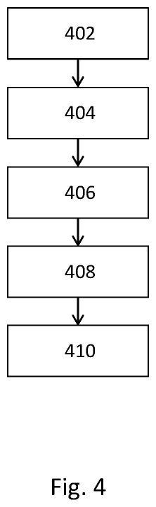

FIG. 4 shows schematically a method 400 of assisting a user in a process. The method comprises: detecting 402 the light emitted by a lighting unit, the light comprising an embedded code being representative of a process phase of the process, extracting 404 the embedded code from the detected light, determining 406 a tool setting for the tool based on the embedded code, receiving 408 a user input to activate the tool, and configuring 410 the tool based on the tool setting such that when the user input is received, the tool is controlled in accordance with the tool setting.

The method 400 may be executed by computer program code of a computer program product when the computer program product is run on a processing unit of a computing device, such as the processor 106 of the system 100.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A system for assisting a user in a process, wherein the process is a production process, the process comprising a plurality of process phases, the system comprising:
a lighting unit configured to emit light comprising an embedded code, the embedded code being representative of a process phase of the process, and
a tool comprising:
a user input element configured to receive a user input to activate the tool,
a light detector configured to detect the light emitted by the lighting unit, and
a processor configured to extract the embedded code from the detected light, to determine a tool setting for the tool based on the embedded code, to configure the tool based on the tool setting such that when the user input is received, the tool is controlled in accordance with the tool setting.

2. The system of claim 1, wherein the system comprises a plurality of lighting units each configured to emit light comprising a respective embedded code, each respective embedded code being representative of a respective process phase of the process, and
wherein the processor is configured to extract a respective embedded code from detected respective light, to determine a respective tool setting for the tool based on the respective embedded code and configure the tool based on the respective tool setting.

3. The system, of claim 1, wherein the tool comprises a user interface, and wherein the processor is configured to, if the embedded code has not been detected or if no tool setting has been determined, provide a notification thereof via the user interface.

4. The system of claim 1, wherein the system comprises a controller configured to instruct the lighting unit to embed data indicating the process phase in the embedded code, and wherein the processor is configured to extract the process phase from the embedded code, and to determine the tool setting for the tool based on the extracted process phase.

5. The system of claim 1, wherein the embedded code is a predefined embedded code, and wherein the processor is configured to access a memory comprising associations between predefined embedded codes and tool settings, and wherein the processor is configured to retrieve the tool setting from the memory by comparing the detected predefined embedded code with the stored predefined embedded codes and by selecting the tool setting that corresponds to the detected predefined embedded code.

6. The system of claim 1, wherein the tool setting comprises an actuation setting for an actuator of the tool.

7. The system of claim 1, wherein the tool setting comprises a deactivation of an actuator of the tool.

8. The system of claim 1, wherein the tool setting comprises an actuation setting for a first actuator of the tool and a deactivation of a second actuator of the tool.

9. The system of claim 1, wherein the lighting unit is a lighting unit for providing illumination of a space where the process phase is to be executed by the user.

10. The system of claim 1, wherein the tool is required during at least two process phases in the process.

11. The system of claim 1, wherein the processor is configured to receive an indication that the process phase has been completed by a user.

12. A tool for use in the system of claim 1, the tool comprising:
a user input element configured to receive a user input to activate the tool,
a light detector configured to detect light emitted by a lighting unit, the light comprising a code embedded in the light, the embedded code being representative of a process phase of the process, and
a processor configured to extract the embedded code from the detected light, to determine a tool setting for the tool based on the embedded code, and to configure the tool based on the tool setting such that when the user input is received, the tool is controlled in accordance with the tool setting.

13. A method of assisting a user in a process, wherein the process is a production process, the process comprising a plurality of process phases, the method comprising:
detecting the light emitted by a lighting unit, the light comprising an embedded code being representative of a process phase of the process,
extracting the embedded code from the detected light,
determining a tool setting for the tool based on the embedded code,
receiving a user input to activate the tool, and
configuring the tool based on the tool setting such that when the user input is received, the tool is controlled in accordance with the tool setting.
